(19) United States
(12) Patent Application Publication
(10) Pub. No.: US 2011/0255058 A1
(43) Pub. Date: Oct. 20, 2011

(54) ELECTRICAL DEVICE AND PROJECTION DISPLAY DEVICE

(75) Inventor: Kazunori Kotani, Nara-City (JP)

(73) Assignee: SANYO ELECTRIC CO., LTD., Osaka (JP)

(21) Appl. No.: 13/088,713

(22) Filed: Apr. 18, 2011

(30) Foreign Application Priority Data
Apr. 20, 2010 (JP) 2010-097417

(51) Int. Cl. G03B 21/16; B01D 46/42; B01D 50/00

(52) U.S. Cl. 353/61; 96/397

(57) ABSTRACT

An electrical device includes a plurality of filters having filter performances different from each other; a filter switching section which switches a filter to be disposed in a channel of a fluid flowing into a main body of the device between the plurality of filters; a switching control section which controls the filter switching section; and a determining section which determines the type of unwanted matter contained in the fluid. In this arrangement, the switching control section controls the filter switching section to dispose the filter corresponding to the type determined by the determining section in the channel.

This application claims priority under 35 U.S.C. Section 119 of Japanese Patent Application No. 2010-97417 filed Apr. 20, 2010, entitled “ELECTRICAL DEVICE AND PROJECTION DISPLAY DEVICE”. The disclosure of the above application is incorporated herein by reference.

### BACKGROUND OF THE INVENTION

1. Field of the Invention

The present invention relates to an electrical device incorporated with a filter, and a projection display device.

2. Disclosure of Related Art

Generally, an electrical device such as a projector, an air conditioner, and an air cleaner for drawing external air into the device is incorporated with a filter which is detachably attached to an air inlet to remove unwanted matter (such as dust and fume) contained in the external air.

In such an electrical device, filters are exchanged as necessary depending on a use environment. For instance, filters of different mesh sizes may be detachably attached to the electrical device depending on a condition in which dust and the like flies.

In the electrical device, the user himself or herself is required to attach a filter suitable for the use environment in filter exchange, which is cumbersome to the user. Further, in some cases, the user may find it difficult to grasp the use environment as to what type of dust and the like flies in the air, which may result in inadequate filter exchange.

### SUMMARY OF THE INVENTION

An electrical device according to a first aspect of the invention includes a plurality of filters having filter performances different from each other; a filter switching section which switches a filter to be disposed in a channel of a fluid flowing into a main body of the electrical device between the plurality of filters; a switching control section which controls the filter switching section; and a determining section which determines the type of unwanted matter contained in the fluid. In this arrangement, the switching control section controls the filter switching section to dispose the filter corresponding to the type determined by the determining section in the channel.

A projection display device according to a second aspect of the invention includes a plurality of filters having filter performances different from each other; a filter switching section which switches a filter to be disposed in a channel of a fluid flowing into a main body of the device between the plurality of filters; a switching control section which controls the filter switching section; and a determining section which determines the type of unwanted matter contained in the fluid. In this arrangement, the switching control section controls the filter switching section to dispose the filter corresponding to the type determined by the determining section in the channel.

### BRIEF DESCRIPTION OF THE DRAWINGS

These and other objects, and novel features of the present invention will become more apparent upon reading the following detailed description of the embodiment along with the accompanying drawings.

FIG. 1 is an external perspective view showing an arrangement of a projector embodying the invention.

FIG. 2 is a diagram showing an arrangement of an optical engine in the embodiment.

FIGS. 3A to 3C are diagrams showing an arrangement of a filter cassette in the embodiment.

FIGS. 4A to 4C are diagrams showing another arrangement of the filter cassette in the embodiment.

FIG. 5 is a block diagram showing a configuration of the projector embodying the invention.

FIG. 6 is a flowchart showing a control process for switching a multi filter in the embodiment.

FIG. 7 is a flowchart showing a control process for switching a multi filter in a first modification.

FIG. 8 is a diagram showing contents of various information for use in multi filter switching control in the first modification.

FIG. 9 is a flowchart showing a control process for detecting clogging of a filter in the first modification.

FIG. 10 is a flowchart showing a control process for switching a multi filter in a second modification.

FIG. 11 is a flowchart showing a control process for switching a multi filter in the second modification.

FIG. 12 is a flowchart showing a control process for detecting clogging of a filter in the second modification.

FIGS. 13A to 13D are diagrams showing an arrangement of a projector in a third modification.

FIG. 14 is a block diagram showing a configuration of the projector in the third modification.

The drawings are provided mainly for describing the present invention, and do not limit the scope of the present invention.

### DESCRIPTION OF PREFERRED EMBODIMENTS

In the following, a projector, as an example of an electrical device and a projection display device embodying the invention, is described referring to the drawings.

In the embodiment, a first filter 409a, a second filter 409b, a first filter 456a, and a second filter 456b correspond to filters in the claims. Wind-up shafts 407, 408 and a wind-up motor 701 constitute a filter switching section in the claims. A support shaft 455 and a rotation motor 711 constitute a filter switching section in the claims. The wind-up motor 701 and the rotation motor 711 correspond to a driving section in the claims. A controller 801 corresponds to a switching control section in the claims. The controller 801 and a dust sensor 92 constitute a determining section in the claims. The description regarding the correspondence between the claims and the embodiment is merely an example, and the claims are not limited by the description of the embodiment.

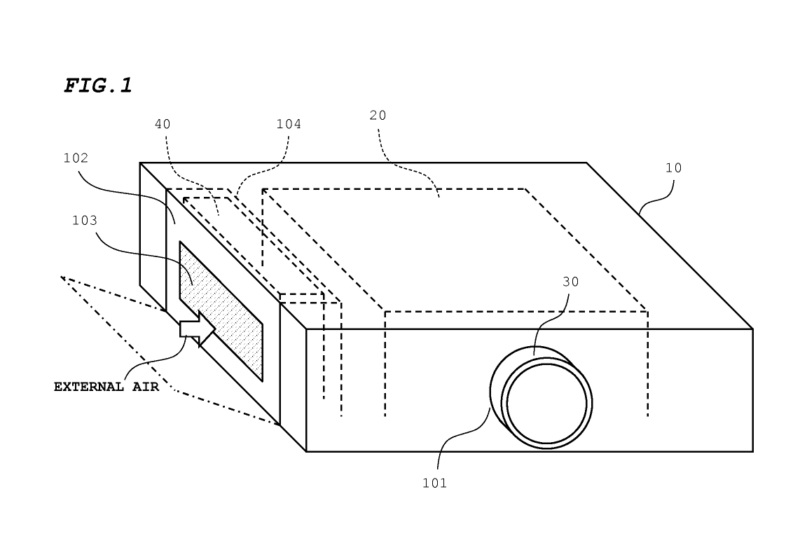

FIG. 1 is an external perspective view showing an arrangement of a projector.

Referring to FIG. 1, the projector is provided with a cabinet 10 having a substantially rectangular parallelepiped shape with a large size in horizontal direction thereof. The cabinet 10 is formed with a projection window 101 in the middle on a front surface thereof. Further, a left surface of the cabinet 10 is formed into an air inlet cover 102 except for a front end and a rear end thereof. The air inlet cover 102 has a hinge structure (not shown) at a lower end thereof. As shown by the one-dotted chain line in FIG. 1, the air inlet cover 102 is swingably opened downward around the lower end as a pivot. The air inlet cover 102 is formed with an air inlet 103 constituted of multitudes of holes.

An optical engine 20 and a projection lens 30 are disposed in the cabinet 10. The optical engine 20 modulates light from a lamp based on an image signal to thereby generate image light. The projection lens 30 is mounted on the optical engine 20, and a front end of the projection lens 30 is exposed forwardly through the projection window 101. The projection lens 30 enlarges and projects the image light generated in the optical engine 20 onto a screen disposed in front of the projector.

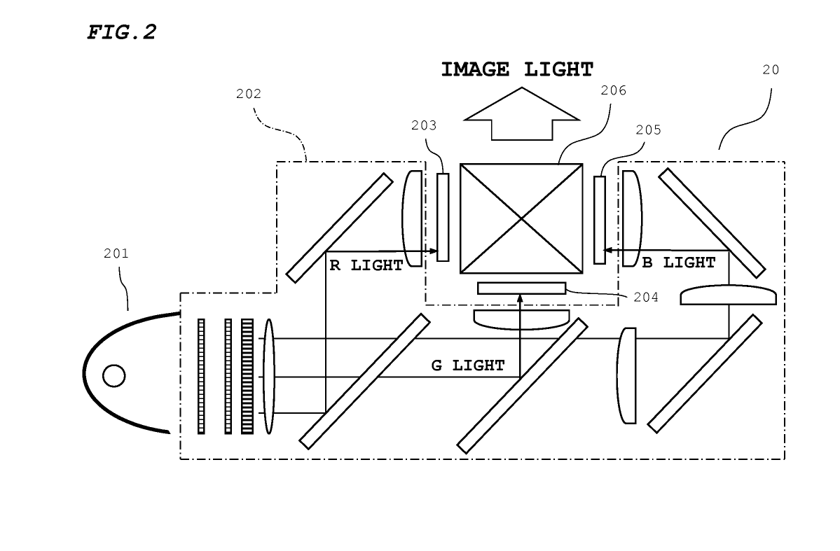

FIG. 2 is a diagram showing an arrangement of the optical engine 20.

As shown in FIG. 2, the optical engine 20 is provided with a lamp 201, a light guiding optical system 202, three transmissive liquid crystal panels 203, 204, 205, and a dichroic prism 206. Unillustrated polarizers are disposed on the incident side and the output side of each of the liquid crystal panels 203, 204, 205.

The lamp 201 is e.g. a metal halide lamp or a xenon lamp. White light emitted from the lamp 201 is separated into light (hereinafter, called as R light) in a red wavelength region, light (hereinafter, called as G light) in a green wavelength region, and light (hereinafter, called as B light) in a blue wavelength region by the light guiding optical system 202. The separated R light, G light, and B light are respectively irradiated onto the liquid crystal panels 203, 204, 205. The R light, G light, B light modulated by the liquid crystal panels 203, 204, 205 are combined by the dichroic prism 206, and the combined light is outputted from the dichroic prism 206 as image light.

An imager constituting the optical engine 20 may be a reflective liquid crystal panel or an MEMS device, in place of the transmissive liquid crystal panels 203, 204, 205. Further alternatively, the optical engine 20 may be an optical system other than the three-panel optical system incorporated with three imagers as described above. For instance, the optical engine 20 may be constituted of a single-panel optical system incorporated with one imager and a color wheel.

Referring back to FIG. 1, a filter attaching portion 104 is formed on the side of an inner left surface of the cabinet 10. A filter cassette 40 is detachably attached to the filter attaching portion 104. A front surface of the filter cassette 40 is covered by the air inlet cover 102. In exchanging the filter cassette 40, the air inlet cover 102 is opened, and the filter cassette 40 is detached from the filter attaching portion 104.

In the following description, a portion of the projector except for the filter cassette 40 is called as a “projector main body” to simplify the description.

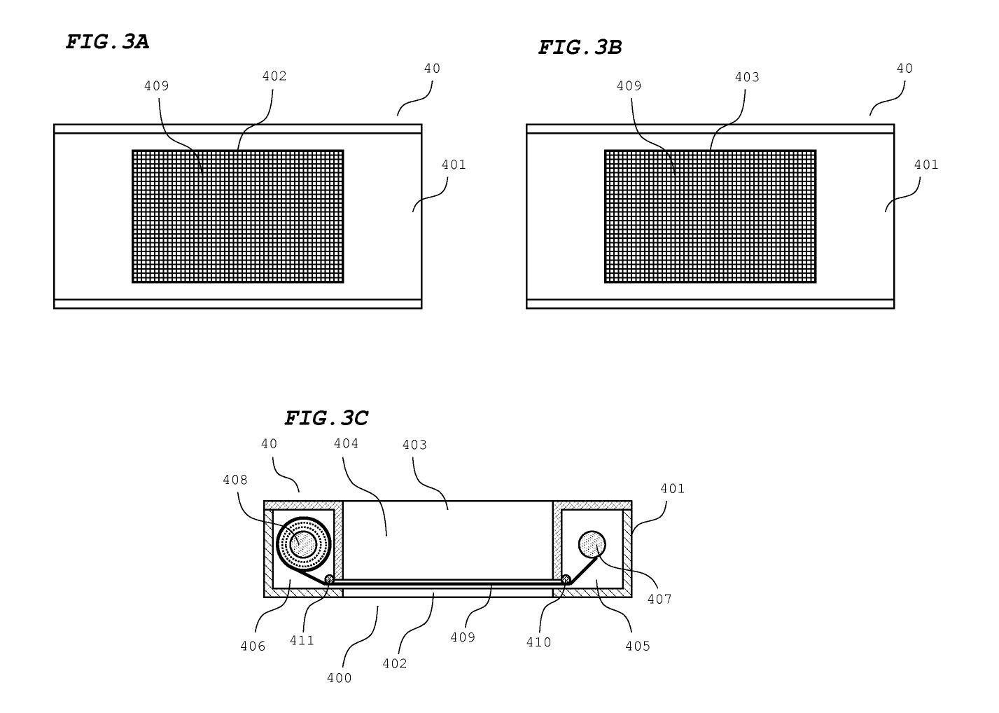

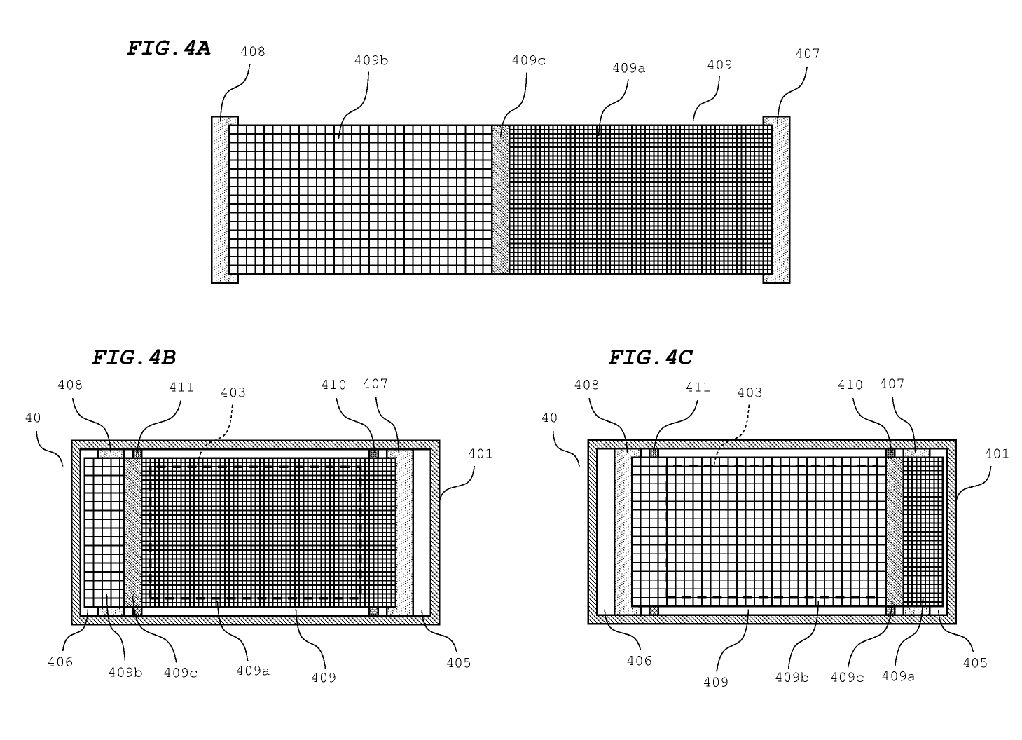

FIGS. 3A to 3C, and 4A to 4C are diagrams showing an arrangement of the filter cassette 40. FIGS. 3A and 3B are respectively a front view and a rear view of the filter cassette 40. FIG. 3C is an internal perspective view of the filter cassette 40 when viewed from above. FIG. 4A is a diagram showing an arrangement of a multi filter 409. FIGS. 4B and 4C are internal perspective view of the filter cassette 40 when viewed from the front side thereof. FIG. 4B shows a state that a first filter 409a is disposed in an air passage 404, and FIG. 4C shows a state that a second filter 409b is disposed in the air passage 404.

Referring to FIGS. 3A to 3C, the filter cassette 40 is provided with a case 401 having a rectangular shape when viewed from the front side thereof. An air intake entrance 402 is formed in the middle on a front surface of the case 401, and an air intake exit 403 is formed in the middle on a rear surface of the case 401. The air passage 404 for passing external air is defined between the air intake entrance 402 and the air intake exit 403. Filter housing portions 405 and 406 are formed at both ends of the air passage 404 in the case 401. A pair of wind-up shafts 407 and 408, and a pair of guide shafts 410 and 411 are rotatably disposed in the filter housing portions 405 and 406.

The sheet-shaped multi filter 409 is wound around the paired wind-up shafts 407 and 408 while extending in the air passage 404.

As shown in FIG. 4A, the multi filter 409 is formed by connecting the first filter 409a and the second filter 409b having filter performances different from each other to be adjacent to each other. The first and second filters 409a and 409b are formed by knitting a resin yarn into a mesh form. The first filter 409a is a filter having a small mesh size, and has a mesh size capable of removing smoke of cigarette having a particle diameter of about several μm. The second filter 409b is a filter having a larger mesh size than the mesh size of the first filter 409a, and has a mesh size capable of removing house dust having a particle diameter of about several ten μm.

The first filter 409a and the second filter 409b are connected to each other in such a manner that an end of the first filter 409a and an end of the second filter 409b are overlapped each other by a certain width. The overlapped portion, in other words, a connecting portion 409c is adhered by e.g. an adhesive agent. Alternatively, the connecting portion 409c may be stitched by a resin yarn in such a manner that lint is not generated from the yarn itself.

Further alternatively, the connecting portion 409c may be subjected to thermal fusion. In this case, however, a molten filter portion may be hardened like a resin plate, which may make it difficult to wind the multi filter 409 around the wind-up shafts 407 and 408. In view of this, it is desirable to connect the first filter 409a and the second filter 409b by adhesion or stitching free of hardening of the connecting portion 409c.

Further alternatively, the first filter 409a and the second filter 409b may be made of polyurethane or non-woven fabric.

As shown in FIG. 4B, when the second filter 409b is wound up by the wind-up shaft 408, the first filter 409a is disposed in the air passage 404. On the other hand, as shown in FIG. 4C, when the first filter 409a is wound up by the wind-up shaft 407, the second filter 409b is disposed in the air passage 404. The multi filter 409 is guided by the guide shafts 410 and 411, and is smoothly moved between the wind-up shaft 407 and the wind-up shaft 408.

When each of cooling fans to be described later is rotated in a state (see FIG. 1) that the filter cassette 40 is attached to the filter attaching portion 104, external air is drawn through the air inlet 103. The drawn external air is supplied into the cabinet 10 through an air inlet (not shown) formed in the filter attaching portion 104 via the air intake entrance 402 of the filter cassette 40, the multi filter 409, and the air intake exit 403.

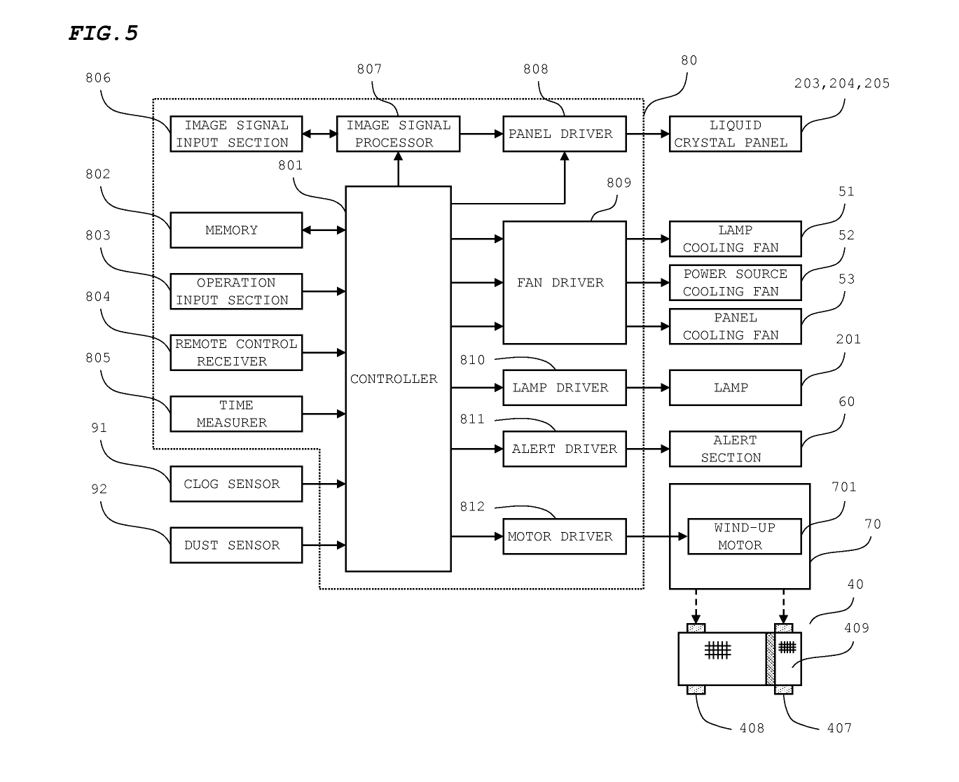

FIG. 5 is a block diagram showing a configuration of the projector.

The projector is provided with three cooling fans i.e. a lamp cooling fan 51, a power source cooling fan 52, and a panel cooling fan 53; and is further provided with an alert section 60, a filter driving mechanism 70, a control circuit section 80, a clog sensor 91, and a dust sensor 92, in addition to the aforementioned elements.

The lamp cooling fan 51 supplies the drawn external air to the lamp 201 to cool the lamp 201. The power source cooling fan 52 supplies the drawn external air to a power source section (not shown) to cool the power source section. The panel cooling fan 53 supplies the drawn external air to the liquid crystal panels 203, 204, 205 to cool the liquid crystal panels 203, 204, 205.

The alert section 60 is constituted of a display element such as an LED and a speaker, and outputs various alerts relating to running of the projector such as an alert to prompt the user to exchange the filter cassette 40.

The filter driving mechanism 70 is provided with a wind-up motor 701. When the filter cassette 40 is attached to the filter attaching portion 104, the two wind-up shafts 407 and 408 are interconnected to the wind-up motor 701 via a transmission mechanism (not shown) of the filter driving mechanism 70. When the wind-up motor 701 is rotated in one direction, the two wind-up shafts 407 and 408 are rotated in the one direction, and the multi filter 409 is wound up toward the wind-up shaft 408. On the other hand, when the wind-up motor 701 is rotated in the other direction opposite to the one direction, the two wind-up shafts 407 and 408 are rotated in the other direction, and the multi filter 409 is wound up toward the wind-up shaft 407.

The control circuit section 80 is provided with a controller 801, a memory 802, an operation input section 803, a remote control receiver 804, a time measurer 805, an image signal input section 806, an image signal processor 807, a panel driver 808, a fan driver 809, a lamp driver 810, an alert driver 811, and a motor driver 812.

The operation input section 803 outputs an input signal to the controller 801 in response to manipulation of a button on an operating section (not shown). The remote control receiver 804 outputs an input signal to the controller 801 in response to manipulation of a button on a remote controller (not shown). The time measurer 805 measures a time and outputs the measured time to the controller 801.

The image signal input section 806 includes various input terminals corresponding to various image signals such as RGB signals and a composite signal, and outputs an image signal inputted from an external device to the image signal processor 807. The image signal processor 807 converts the image signal inputted from the image signal input section 806 into image signals of RGB which are displayable on the liquid crystal display panels 203, 204, 205; and outputs the converted image signals to the panel driver 808. The panel driver 808 drives the liquid crystal panels 203, 204, 205 in accordance with the inputted image signals and a control signal from the controller 801.

The fan driver 809 drives the lamp cooling fan 51, the power source cooling fan 52, and the panel cooling fan 53 in accordance with a control signal from the controller 801. The lamp driver 810 drives the lamp 201 in accordance with a control signal from the controller 801.

The alert driver 811 drives the LED and the speaker of the alert section 60 in accordance with a control signal from the controller 801. The motor driver 812 drives the wind-up motor 701 in accordance with a control signal from the controller 801.

The memory 802 is constituted of an RAM, an ROM, and the like. A control program for providing a control function to the controller 801 is stored in the memory 802. The controller 801 is provided with a CPU to control various parts of the control circuit section 80 in accordance with the control program.

The clog sensor 91 outputs a clog signal corresponding to a degree of clogging of the multi filter 409 to the controller 801. The clog sensor 91 is constituted of e.g. an air flow rate sensor. The air flow rate sensor is disposed in e.g. the air inlet of the filter attaching portion 104. When clogging of the multi filter 409 is increased, the flow rate of air passing through the air inlet is lowered. The air flow rate sensor outputs a detection voltage corresponding to the air flow rate, as a clog detection signal.

The dust sensor 92 is disposed in the air inlet 103 of the air inlet cover 102. The dust sensor 92 is provided with a detection window through which external air passes, and a light emitting element and a light receiving element which face the detection window. Light emitted from the light emitting element into the detection window is reflected by unwanted matter (such as house dust or smoke of cigarette) contained in the external air, and the reflected light is received by the light receiving element. The light receiving element outputs a pulse signal to the controller 801 at a timing of receiving the light reflected on the unwanted matter. The controller 801 determines whether the concentration of unwanted matter passing through the detection window is high or low, based on the number of pulse signals per unit time. If the concentration of unwanted matter is high, the controller 801 determines that the unwanted matter is smoke of cigarette, and if the concentration of unwanted matter is low, the controller 801 determines that the unwanted matter is house dust.

In this embodiment, switching of the multi filter 409 of the filter cassette 40 is performed depending on the type of unwanted matter contained in the drawn external air.

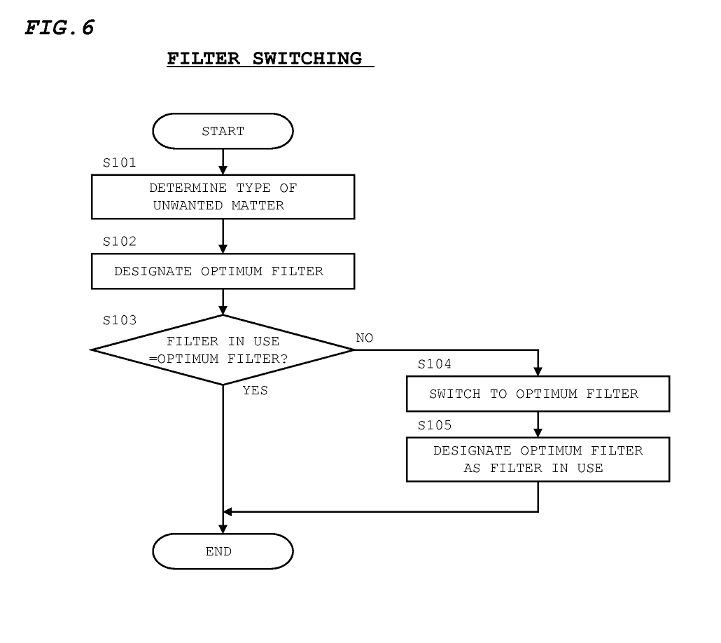

FIG. 6 is a flowchart showing a control process for switching the multi filter 409. The filter switching control process is executed each time the projector is run, and an operation of drawing air into the cabinet 10 is started.

Referring to FIG. 6, the controller 801 causes the dust sensor 92 to detect unwanted matter, and determines the type of unwanted matter (S101). Then, the controller 801 designates an optimum filter based on the determination result (S102). Specifically, if it is determined that the unwanted matter is smoke of cigarette, the controller 801 designates the first filter 409a having a small mesh size as an optimum filter. If, on the other hand, it is determined that the unwanted matter is house dust, the controller 801 designates the second filter 409b having a large mesh size as an optimum filter.

Then, the controller 801 determines whether the currently used filter (hereinafter, called as “the filter in use”) is the designated optimum filter (S103). Information as to which one of the filters 409a and 409b is the filter in use is stored in the memory 802.

If it is determined that the filter in use is the designated optimum filter (S103:YES), the controller 801 terminates the process. If, on the other hand, it is determined that the filter in use is not the designated optimum filter (S103:NO), the controller 801 causes the wind-up motor 701 to drive to switch the multi filter 409 so that the designated optimum filter is usable (S104). Then, the controller 801 designates the filter that is newly disposed in the air passage 404 as the filter in use, and causes the memory 802 to store the information relating to the newly disposed filter therein (S105).

As described above, in this embodiment, the type of unwanted matter contained in the external air is discriminated, and the filter corresponding to the discriminated type of filter is disposed in the air passage 404. With this arrangement, it is possible to use a filter suitable for the use environment, without the need of an exchange operation by the user. In other words, in the case where the unwanted matter is smoke of cigarette and the particle diameter of the unwanted matter is small, the first filter 409a having a small mesh size is used. This enables to satisfactorily remove the smoke of cigarette. Further, in the case where the unwanted matter is house dust and the particle diameter of the unwanted matter is large, the second filter 409b having a large mesh size is used. This enables to reduce the resistance of the filter against an airflow, and improve the airflow. In this way, improving the airflow and increasing the air flow rate enables to reduce the rotation numbers of the cooling fans 51, 52, 53 by the increased air flow rate to thereby suppress noise.

As described above, in the embodiment, a filter suitable for the use environment can be used without the need of an exchange operation by the user. This provides a projector with enhanced usability.

### First Modification

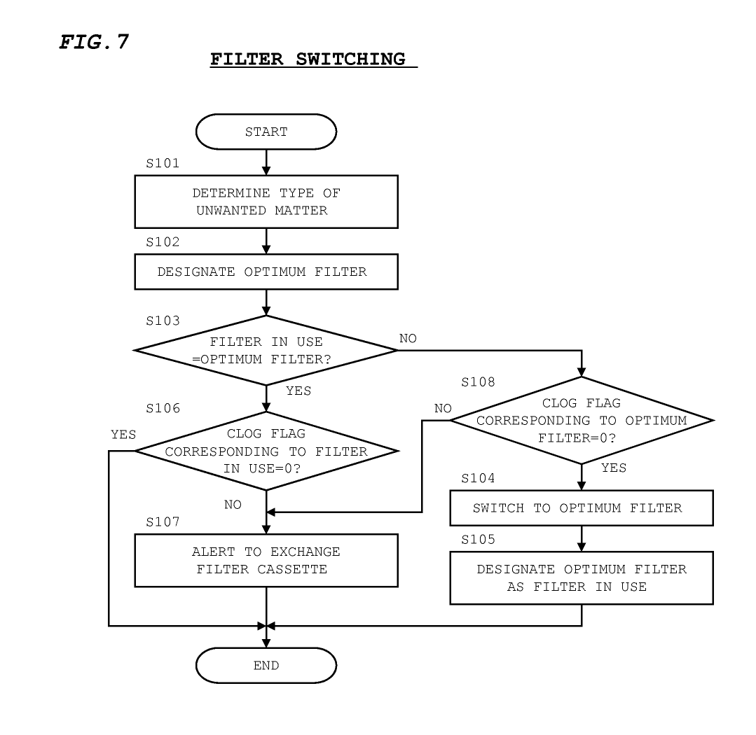

FIG. 7 is a flowchart showing a control process for switching the multi filter 409 in the first modification.

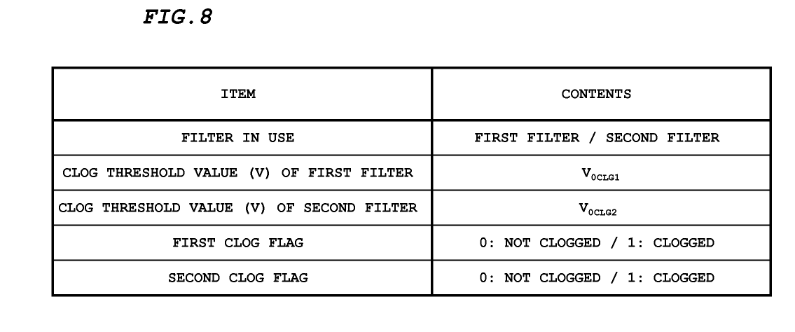

In this modification, operations from Step S106 to Step S108 are added to the control process shown in FIG. 6. Further, as shown in the table of FIG. 8, the memory 802 stores clog threshold values for the first and second filters 409a and 409b, in addition to the information as to which one of the filters 409a and 409b is the filter in use. The memory 802 further stores a first clog flag for determining clogging of the first filter 409a, and a second clog flag for determining clogging of the second filter 409b. The first clog flag is reset to “0” when the first filter 409a is not clogged, and is set to “1” when the first filter 409a is clogged. The second clog flag is reset to “0” when the second filter 409b is not clogged, and is set to “1” when the second filter 409b is clogged.

Referring to FIG. 7, in this modification, if it is determined that the filter in use is the designated optimum filter in Step S103 (S103:YES), the controller 801 determines whether the clog flag corresponding to the filter in use is reset (S106).

If the clog flag is reset (S106:YES), the controller 801 terminates the process. If, on the other hand, the clog flag is set (S106:NO), the controller 801 causes the alert section 60 to output an alert to prompt the user to exchange the filter cassette 40 because the filter in use is clogged (S107). The user who is notified of the alert terminates the running of the projector, and exchanges the filter cassette 40 with a new filter cassette 40. When the new filter cassette 40 is attached and a reset operation is performed by the user, the clog flag is reset.

Further, in this modification, if it is determined that the filter in use is not the designated optimum filter in Step S103 (S103:NO), the controller 801 determines whether the clog flag corresponding to the designated optimum filter to be used is reset (S108). If the clog flag is reset (S108:YES), the filter in use is switched to the designated optimum filter (S104). If, on the other hand, the clog flag is set (S108:NO), the controller 801 causes the alert section 60 to output an alert to prompt the user to exchange the filter cassette 40 because the designated optimum filter to be used is clogged.

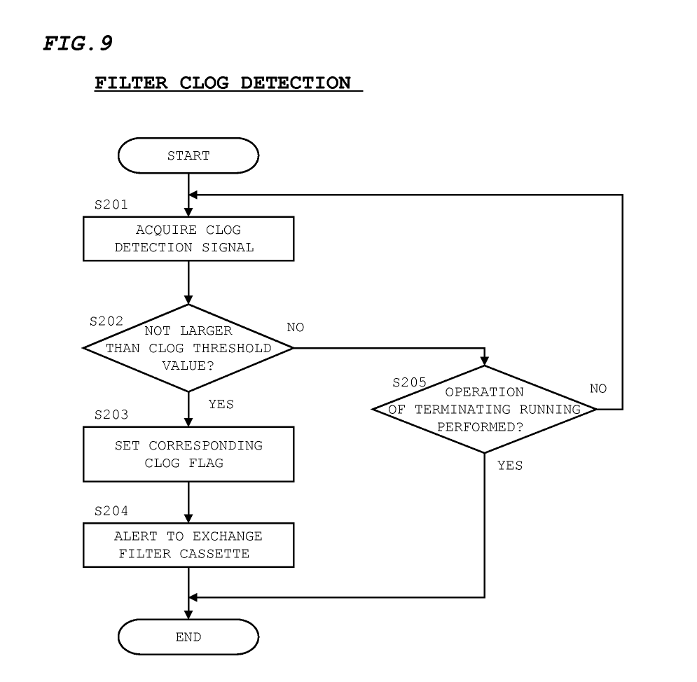

FIG. 9 is a flowchart showing a control process for detecting filter clogging in the first modification. The clog flag is reset in advance, and is set when filter clogging is detected during running of the projector.

Referring to FIG. 9, the controller 801 acquires a clog detection signal (detection voltage) from the clog sensor 91 (S201). Then, the controller 801 compares between the acquired clog detection signal and the clog threshold value corresponding to the filter in use (S202). If the filter in use is not clogged, and the clog detection signal is larger than the clog threshold value (S202:NO), the controller 801 repeats a series of operations of acquiring a clog detection signal and comparing between the acquired clog detection signal and the clog threshold value until an operation of terminating the running of the projector is performed and the running is terminated (S205:YES).

If, on the other hand, the filter in use is clogged, and the acquired clog detection signal is not larger than the clog threshold value (S202:YES), the controller 801 sets the clog flag corresponding to the filter in use (S203). Then, the controller 801 causes the alert section 60 to output an alert to prompt the user to exchange the filter cassette 40 (S204). At this point of time, if the user does not exchange the filter cassette 40, the controller 801 causes the alert section 60 to output an alert to prompt the user to exchange the filter cassette 40 again in a filter switching control process to be executed during running of the projector next time because the clog flag is kept in a set state.

As described above, the arrangement of this modification is advantageous in using a filter free of clogging and having satisfactory filter performance.

### Second Modification

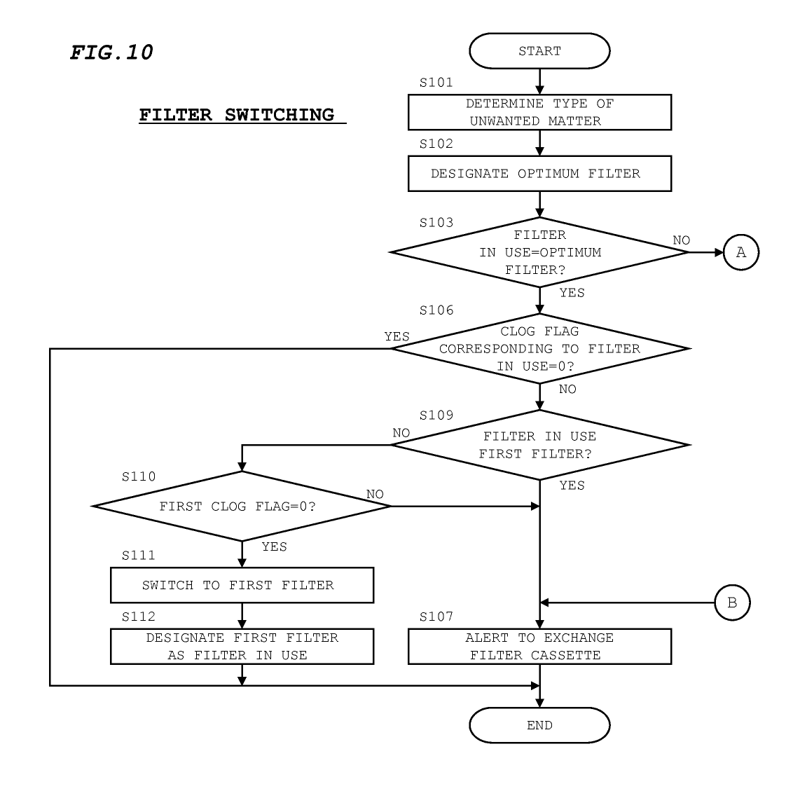

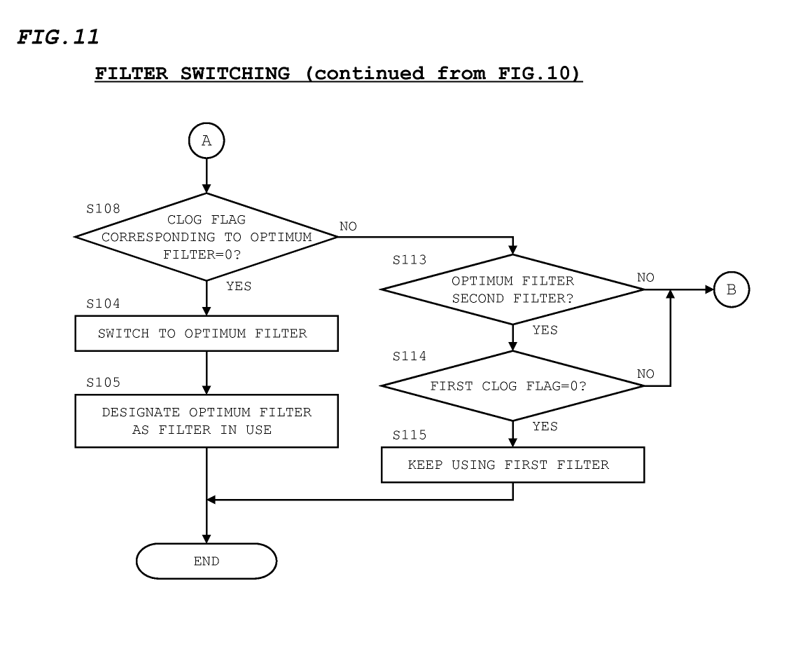

FIG. 10 and FIG. 11 are flowcharts showing a control process for switching the multi filter 409 in the second modification.

In this modification, operations from Step S109 to Step S115 are added to the control process shown in FIG. 7.

Referring to FIG. 10, in this modification, if it is determined that the clog flag corresponding to the filter in use is set in Step S106 (S106:NO), the controller 801 determines whether the filter in use is the first filter 409a (S109).

If it is determined that the unwanted matter is smoke of cigarette in Step S101, it is determined that the filter in use is the first filter 409a in Step S109 because it is determined that the filter in use is the designated optimum filter in Step S103. If, on the other hand, it is determined that the unwanted matter is house dust in Step S101, it is determined that the filter in use is the second filter 409b in Step S109.

If the unwanted matter contained in the external air is smoke of cigarette having a small particle diameter, even if the clogged first filter 409a is switched to the second filter 409b having a large mesh size, it is impossible to remove smoke of cigarette. If, on the other hand, the unwanted matter contained in the external air is house dust having a large particle diameter, switching the clogged second filter 409b to the first filter 409a having a small mesh size enables to remove house dust.

If the filter in use is the first filter 409a, it is impossible to remove the unwanted matter (smoke of cigarette) even if the multi filter 409 is switched. In view of the above, if it is determined that the filter in use is the first filter 409a (S109:YES), the controller 801 causes the alert section 60 to output an alert to prompt the user to exchange the filter cassette 40 (S107).

If, on the other hand, the filter in use is the second filter 409b, switching to the first filter 409a enables to remove the unwanted matter (house dust). In view of the above, if it is determined that the filter in use is the second filter 409b (S109:NO), the controller 801 determines the state of the first clog flag corresponding to the first filter 409a (S110). If the first filter 409a is not clogged and the clog flag is reset (S110:YES), the controller 802 switches the multi filter 409 to the first filter 409a (S111). Then, the controller 801 designates the first filter 409a that is newly disposed in the air passage 404 as the filter in use, and causes the memory 802 to store the information indicating that the filter in use is the first filter 409a therein (S112).

In the case where the first filter 409a is clogged, it is determined that the first clog flag is set in Step S110. In this case, since the first filter 409a is unusable, the controller 801 causes the alert section 60 to output an alert to prompt the user to exchange the filter cassette 40 (S107).

Referring to FIG. 11, in this modification, if it is determined that the clog flag corresponding to the designated optimum filter to be used is set in Step S108 (S108:NO), the controller 801 determines whether the designated optimum filter to be used is the second filter 409b (S113).

If it is determined that the designated optimum filter to be used is the second filter 409b, the currently used filter is the first filter 409a. In this case, the unwanted matter is house dust because the designated optimum filter to be used is the second filter 409b. In this condition, the unwanted matter can be removed by keeping using the first filter 409a.

Then, if it is determined that the designated optimum filter to be used is the second filter 409b (S113:YES), the controller 801 determines the state of the first clog flag (S114). If the first filter 409a is not clogged and the clog flag is reset (S114:YES), the controller 801 causes the multi filter 409 to keep using the first filter 409a without switching the multi filter 409 (S115).

If, on the other hand, it is determined that the designated optimum filter to be used is the first filter 409a, the currently used filter is the second filter 409b. In this case, the unwanted matter is smoke of cigarette because the designated optimum filter to be used is the first filter 409a. In this condition, it is impossible to remove the unwanted matter even if the second filter 409b is kept being used.

In view of the above, if it is determined that the designated optimum filter to be used is the first filter 409a (S113:NO), the controller 801 causes the alert section 60 to output an alert to prompt the user to exchange the filter cassette 40 (S107).

Similarly to the above, in the case where the first clog flag is set in Step S114, the first filter 409a is clogged, and therefore, the first filter 409a is unusable. In this condition, the controller 801 causes the alert section 60 to output an alert to prompt the user to exchange the filter cassette 40 (S107).

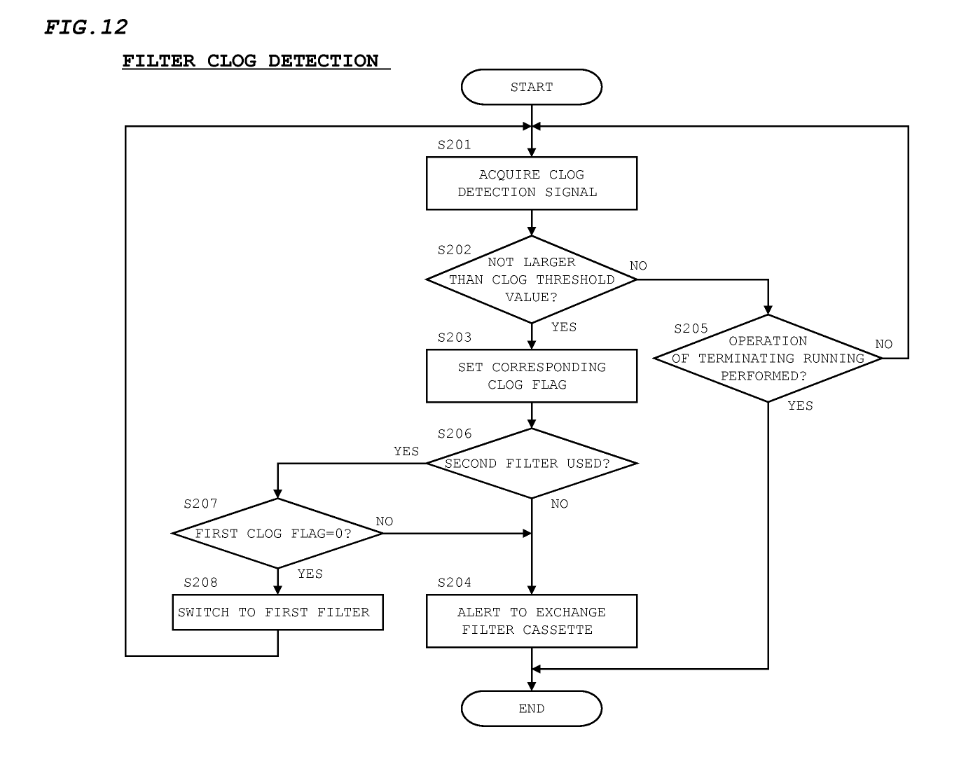

FIG. 12 is a flowchart showing a control process for detecting filter clogging in the second modification.

In this modification, operations from Step S206 to Step S208 are added to the control process shown in FIG. 9.

Referring to FIG. 12, in this modification, the controller 801 sets the clog flag corresponding to the filter in use in Step S203 because the filter in use is clogged. Then, the controller 801 determines whether the filter in use is the second filter 409b (S206).

In the case where it is determined that the second filter 409b is the filter in use, the unwanted matter is house dust. In this condition, it is possible to remove the unwanted matter by switching the multi filter 409 to the first filter 409a. In view of this, if it is determined that the filter in use is the second filter 409b (S206:YES), the controller 801 determines the state of the first clog flag (S207). If the first filter 409a is not clogged, and the clog flag is reset (S207:YES), the multi filter 409 is switched to the first filter 409a (S208).

If it is determined that the filter in use is the first filter 409a in Step S206 (S206:NO), and if it is determined that the first clog flag is set in Step S207 (S207:NO), the controller 801 causes the alert section 60 to output an alert to prompt the user to exchange the filter cassette 40 because there is no room for switching the multi filter 409 (S204).

As described above, in this modification, in the case where the second filter 409b which should be used as an optimum filter is clogged, the first filter 409a having a smaller mesh size than the mesh size of the second filter 409b is used. This enables to secure the filter performance of removing unwanted matter and continue running of the projector, although the air in-take rate may be slightly lowered.

### Third Modification

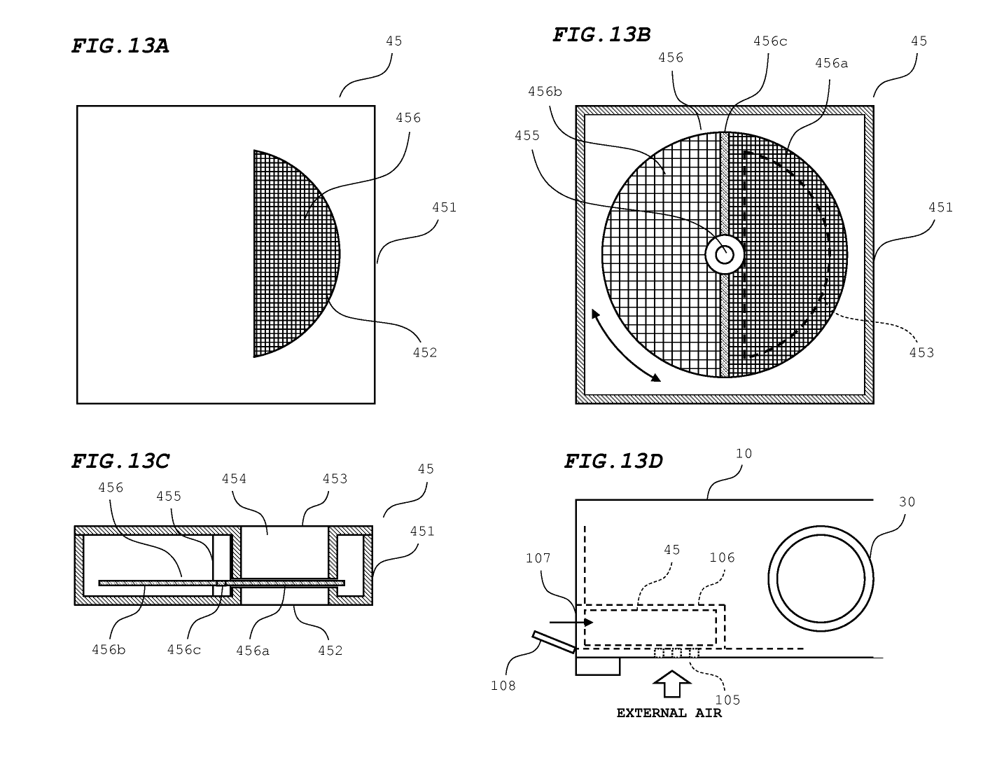

FIGS. 13A to 13D are diagrams showing an arrangement of the projector in the third modification. FIG. 13A is a front view of a filter cassette 45. Further, FIGS. 13B and 13C are respectively internal perspective views of the filter cassette 45 when viewed from the front side and from above. Furthermore, FIG. 13D is a front view of essential parts of the projector showing a state that the filter cassette 45 is attached.

Referring to FIGS. 13A to 13C, the filter cassette 45 is provided with a case 451 of a substantially square shape when viewed from the front side thereof. A front surface of the case 451 is formed with a substantially semi-circular air intake entrance 452 at a position closer to one side thereof. Further, a rear surface of the case 451 is formed with an air intake exit 453 at a position corresponding to the air intake entrance 452. An air passage 454 through which external air passes is defined between the air intake entrance 452 and the air intake exit 453. A support shaft 455 is rotatably disposed in the case 451, and extends along the lengthwise direction of the air passage 454.

A disc-shaped multi filter 456 is attached to the support shaft 455. As shown in FIG. 13B, the multi filter 456 is formed by connecting substantially semi-circular first filter 456a and second filter 456b having filter performances different from each other. The first and second filters 456a and 456b are formed by e.g. knitting a resin yarn into a mesh form. The first filter 456a is a filter having a small mesh size, and has a mesh size capable of removing smoke of cigarette. The second filter 456b is a filter having a larger mesh size than the mesh size of the first filter 456a, and has a mesh size capable of removing house dust. The first filter 456a and the second filter 456b may be made of polyurethane or non-woven fabric.

A connecting portion 456c between the first filter 456a and the second filter 456b is adhered by e.g. an adhesive agent. Alternatively, the connecting portion 456c may be stitched by a resin yarn in such a manner that lint is not generated from the yarn itself.

The filter to be disposed in the air passage 454 is switched between the first filter 456a and the second filter 456b by rotating the support shaft 455.

As shown in FIG. 13D, the projector main body is formed with an air inlet 105 in a bottom surface of the cabinet 10. Further, a filter attaching portion 106 is formed above the air inlet 105. The filter cassette 45 is housed in the filter attaching portion 106 through an insertion opening 107 formed in a left surface of the cabinet 10. The insertion opening 107 is opened and closed by a cover 108.

The air intake entrance 452 is aligned with the air inlet 105 in a state that the filter cassette 45 is attached to the filter attaching portion 106. External air drawn through the air inlet 105 is supplied into the cabinet 10 through an air inlet (not shown) formed in the filter attaching portion 106 via the air intake entrance 452 of the filter cassette 45, the multi filter 456, and the air intake exit 453.

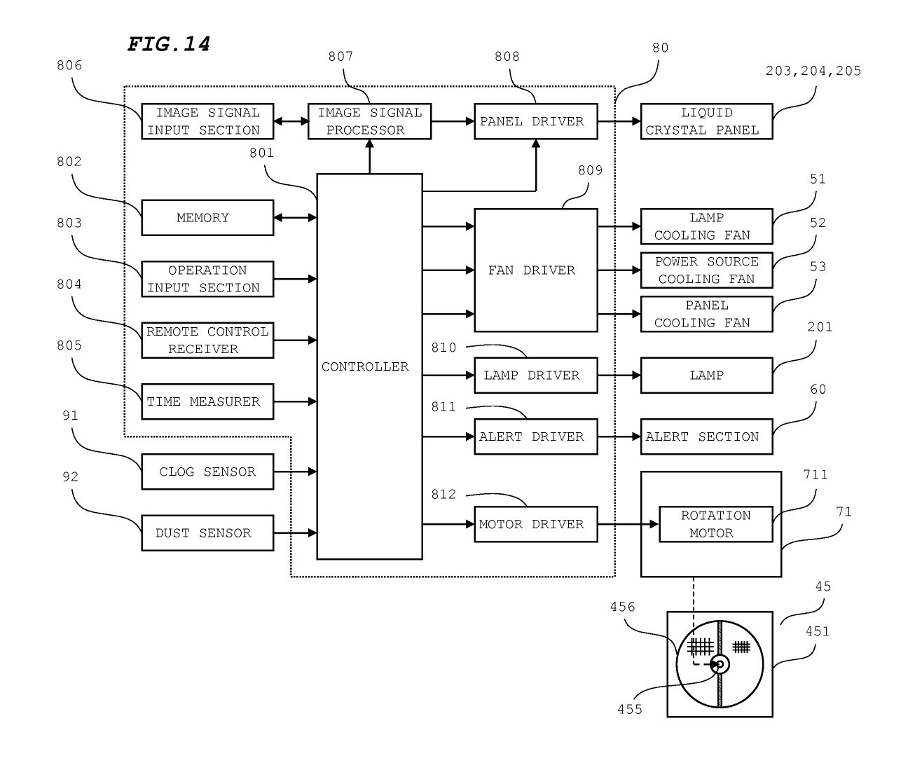

FIG. 14 is a block diagram showing a configuration of the projector in the third modification.

In this modification, a filter driving mechanism 71 is provided in place of the filter driving mechanism 70 in the embodiment. The third modification is substantially the same as the embodiment except for the above arrangement.

The filter driving mechanism 71 is provided with a rotation motor 711. When the filter cassette 45 is attached to the filter attaching portion 106, the support shaft 455 is interconnected to the rotation motor 711 via a transmission mechanism (not shown) of the filter driving mechanism 71.

When the rotation motor 711 is rotated, the support shaft 455 is rotated to switch the multi filter 456.

Similarly to the embodiment, and the first and second modifications, in this modification, the filter switching control process as described in the embodiment, and the first and second modifications is performed.

Accordingly, the third modification provides substantially the same operation and effect as described in the embodiment, and the first and second modifications.

### Other Modifications

The embodiment of the invention has been described as above. The invention is not limited to the foregoing embodiment and the modifications, and the embodiment of the invention may be modified in various ways other than the above.

For instance, in the embodiment, the multi filter 409 is constituted of the two filters 409a and 409b having filter performances different from each other. Alternatively, a multi filter may be constituted of three or more filters having filter performances different from each other. Further alternatively, the multi filter 456 in the third modification may also be constituted of three or more filters having filter performances different from each other.

Further, in the embodiment, an air flow rate sensor is used as the clog sensor 91. Alternatively, a temperature sensor may be used as the clog sensor. In the modification, for instance, the temperature sensor is operable to measure temperatures of the liquid crystal panels 203, 204, 205; and the lamp 201. When the filter is clogged and the air intake rate is lowered, the cooling performances of the panel cooling fan 53 and the lamp cooling fan 51 are lowered, which may raise a temperature to be measured by the temperature sensor. The temperature sensor outputs a detection signal (detection voltage) corresponding to the measured temperature to the controller 801.

Further, in the embodiment, a projector is described as an example of the invention. Alternatively, the invention may be applied to other electrical device having a filter, such as an air conditioner and an air cleaner.

The embodiment of the invention may be changed or modified in various ways as necessary, as far as such changes and modifications do not depart from the scope of the claims of the invention hereinafter defined.

What is claimed is:

1. An electrical device, comprising:
a plurality of filters having filter performances different from each other;
a filter switching section which switches a filter to be disposed in a channel of a fluid flowing into a main body of the electrical device between the plurality of filters;
a switching control section which controls the filter switching section; and
a determining section which determines the type of unwanted matter contained in the fluid, wherein
the switching control section controls the filter switching section to dispose the filter corresponding to the type determined by the determining section in the channel.

2. The electrical device according to claim 1, wherein
the plurality of filters have mesh sizes different from each other, and
the switching control section controls the filter switching section to dispose a filter having a small mesh size out of the plurality of filters in the channel when the unwanted matter has a small particle diameter.

3. The electrical device according to claim 2, further comprising:
a clog detecting section which detects clogging of the filter, wherein
in the case where the filter corresponding to the type determined by the determining section is not clogged, the switching control section controls the filter switching section to dispose the non-clogged filter in the channel.

4. The electrical device according to claim 3, wherein
in the case where the filter corresponding to the type determined by the determining section is clogged, the switching control section controls the filter switching section to dispose a filter having a smaller mesh size than the mesh size of the clogged filter out of the plurality of filters in the channel.

5. The electrical device according to claim 1, wherein
the filter switching section includes a pair of wind-up shafts, and a driving section which rotates the paired wind-up shafts,
the plurality of filters are wound around the paired wind-up shafts, the filters being connected to be adjacent to each other, and
the filters are switched by rotating the paired wind-up shafts.

6. The electrical device according to claim 1, wherein
the filter switching section includes a support shaft, and a driving section which rotates the support shaft,
the plurality of filters are supported by the support shaft, and
the filters are switched by rotating the support shaft.

7. A projection display device, comprising
a plurality of filters having filter performances different from each other;
a filter switching section which switches a filter to be disposed in a channel of a fluid flowing into a main body of the device between the plurality of filters;
a switching control section which controls the filter switching section; and
a determining section which determines the type of unwanted matter contained in the fluid, wherein
the switching control section controls the filter switching section to dispose the filter corresponding to the type determined by the determining section in the channel.

8. The projection display device according to claim 7, wherein
the plurality of filters have mesh sizes different from each other, and
the switching control section controls the filter switching section to dispose a filter having a small mesh size out of the plurality of filters in the channel when the unwanted matter has a small particle diameter.

9. The projection display device according to claim 8, further comprising:
a clog detecting section which detects clogging of the filter, wherein
in the case where the filter corresponding to the type determined by the determining section is not clogged, the switching control section controls the filter switching section to dispose the non-clogged filter in the channel.

10. The projection display device according to claim 9, wherein
in the case where the filter corresponding to the type determined by the determining section is clogged, the switching control section controls the filter switching section to dispose a filter having a smaller mesh size than the mesh size of the clogged filter out of the plurality of filters in the channel.

11. The projection display device according to claim 7, wherein
the filter switching section includes a pair of wind-up shafts, and a driving section which rotates the paired wind-up shafts,
the plurality of filters are wound around the paired wind-up shafts, the filters being connected to be adjacent to each other, and
the filters are switched by rotating the paired wind-up shafts.

12. The projection display device according to claim 7, wherein
the filter switching section includes a support shaft, and a driving section which rotates the support shaft,
the plurality of filters are supported by the support shaft, and
the filters are switched by rotating the support shaft.
